(19) United States
(12) Patent Application Publication
(10) Pub. No.: US 2003/0196125 A1
(43) Pub. Date: Oct. 16, 2003

(54) Method of powering on and off a computer using a standard keyboard

(75) Inventor: Patrick L. Ferguson, Cypress, TX (US)

Correspondence Address: AKIN, GUMP, STRAUSS, HAUER & FELD, L.L.P., 300 WEST 6TH STREET, SUITE 2100, AUSTIN, TX, 78701, US

(73) Assignee: Compaq Information Technologies Group, L.P., Houston, TX

(21) Appl. No.: 10/109,589

(22) Filed: Mar. 28, 2002

(51) Int. Cl. G06F 1/26

(52) U.S. Cl. 713/300

(57) ABSTRACT

A power control feature in a computer system. The power control feature includes a host having a motherboard with a first connector that allows motherboard signals to be shared internal to the host. The motherboard also has a second connector separate from the first connector that supports communications with the host. An extension transmitter card is included within the host and is electrically coupled to the motherboard of the host via at least the first connector and the second connector. The extension transmitter card includes an extension transmitter device that has circuitry configured to recognize specific programmable key code combinations from a keyboard. One function of the key code combinations is to indicate powering on or off the host. An extension receiver is also included in the computer system and is connected to a plurality of user interface devices including the keyboard. The extension receiver is extensibly connected to the extension transmitter card.

The present application is related to the following U.S. applications which are incorporated by reference in their entireties: U.S. application Ser. No. 10/035,757, filed Dec. 31, 2001, entitled “Method Of Connecting To A KVM Transmitter Using Internal Cables” by Ferguson et al. (Attorney Docket No. P01-3861); U.S. application Ser. No. 10/035,778, filed Dec. 31, 2001, entitled “Solution For Integrating A KVM Extension Transmitter With A Graphics Controller On An Add-In Card” by Ferguson et al. (Attorney Docket No. P01-3860); U.S. application Ser. No. ______, filed concurrently herewith, entitled “Method Of Supporting Audio For KVM Extension In A Server” by Ferguson et al. (Attorney Docket No. P01-3862); and U.S. application Ser. No. ______, filed concurrently herewith, entitled “Enumeration, Manageability, and Security Of A KVM Extension Device” by Ferguson (Attorney Docket No. P01-3863).

### BACKGROUND OF THE INVENTION

Standard computer interfaces such as keyboard, mouse, video, and audio are often referred to as KVM (“keyboard, video, mouse”) products. “KVM extension” can be defined as extending the access points for computer user interfaces such as keyboards, mice, monitors, etc., i.e., user interfaces may operate with a host processor although positioned outside the standard operating range for the user interface products. The KVM extension mode of operation typically supports user I/O protocols, sometimes referred to as “legacy” protocols, such as PS/2, analog video, and serial. Computers also typically have a power button that, assuming the external power source is connected to the computer, is used for three distinct operations: 1) turning the computer on, 2) turning the computer off, and 3) forcing the computer to shutdown via a 4-second override when the computer is frozen and the operating system is not responding to standard power button signals. Although KVM extension products are particularly useful when dealing with rack mounted computer solutions where the computers of the rack are positioned away from the user interface products, among other things, the power button is typically inaccessible to the user when a user accesses the computer via KVM extension products.

The current method of supporting the power button in a KVM extension architecture is to insert a power switchbox between the computer and the external power source that is controlled by an external cable from an extension transmitter or other management device. The computer is turned off by disabling the external power source and turned on by enabling the external power source and configuring the computer to turn on when external power is applied. However, this method of powering on and off a computer is inconvenient and requires additional hardware to operate.

Many other problems and disadvantages of the prior art will become apparent to one skilled in the art after comparing such prior art with the present invention as described herein.

### BRIEF SUMMARY OF THE INVENTION

Various aspects of the present invention may be realized with a power control feature in a computer system. The power control feature includes a host having a motherboard with a first connector that allows motherboard signals to be shared internal to the host. The motherboard also has a second connector separate from the first connector that supports communications with the host. An extension transmitter card is included within the host and is electrically coupled to the motherboard of the host via at least the first connector and the second connector. The extension transmitter card includes an extension transmitter device that has circuitry configured to recognize specific programmable key code combinations from a keyboard. One function of the programmable key code combinations is to indicate powering on or off the host. An extension receiver is also included in the computer system and is connected to a plurality of user interface devices including the keyboard. The extension receiver is extensibly connected to the extension transmitter card.

The extension transmitter card of the computer system's power control feature may include a peripheral connection interface graphics controller that communicates with the motherboard independent of communications on the first connector. On the other hand, the extension transmitter card may include an accelerated graphics port controller that communicates with the motherboard independent of communications on the first connector. The plurality of user interface devices of the computer system, among other things, includes the keyboard, a mouse, a video monitor, a speaker, a serial link, a USB link, and a microphone. The extension receiver may be extensibly connected to the extension transmitter via a fiber optic cable or a cable compatible with any version of category five or above type cables. The extension transmitter card of the host may be electrically connected to the first connector of the motherboard of the host via a ribbon cable between the motherboard and the extension transmitter card. The extension transmitter card of the host is electrically coupled to the second connector of the motherboard of the host via one of a PCI, PCI-X, or AGP interface with the extension transmitter card.

One of the possible specific programmable key code combinations of the computer system is a CTRL, ALT, and PAGEUP key combination that powers on the host when activated. Another of the possible specific programmable key code combinations is a CTRL, ALT, and PAGEDOWN key combination that powers off the host when activated. In some cases, activating the specific programmable key code combination involves holding the key combination for at least 4 seconds to override a frozen or locked-up computer system. Of course, as the key code combinations are programmable, the combinations may be selected for individual preference by the user.

Another aspect of the present invention may be realized via a power control feature in a computer system. The computer system includes a host having a motherboard, and a keyboard electrically coupled to the motherboard. The motherboard has circuitry that is configured to recognize programmable key code combinations from the keyboard such that powering of the host may be controlled by depressing a specifically programmed key combination at the keyboard.

In some cases, the keyboard is located remotely from the host and motherboard. However, if programmed, a CTRL, ALT, and PAGEUP key combination at the keyboard may still power on the host when activated. Alternatively, when programmed, a CTRL, ALT, and PAGEDOWN key combination powers off the host when activated. Also, when powering off the computer, the specific key combination may activate a specific key code after holding the key combination for at least 4 seconds. It is to be understood that the key code combinations are implemented with PS/2, USB, or other type of implementation protocol.

Still other aspects of the present invention may be realized through a method for power control in a computer using a standard keyboard. The method involves, not necessarily in this order, electrically connecting the keyboard to the computer; depressing a specifically programmed key combination on the keyboard such that a unique key code sequence is transmitted to the computer; the computer identifying the unique key code as a power control sequence; and the computer bypassing software layer operations to enable internal power to be controlled by the power control sequence upon its receipt from the keyboard by linking the keyboard circuitry directly to the power button circuitry.

The standard keyboard may be positioned remotely from the computer and depressing the specifically programmed key combination on the keyboard powers on the computer and may be accomplished by depressing and holding a CTRL key on the keyboard; depressing and holding an ALT key on the keyboard; depressing a PAGEUP key on the keyboard; and releasing the CTRL, ALT, and PAGEUP keys. Depressing the specific key combination on the keyboard could also power off the computer and may be accomplished by depressing and holding a CTRL key on the keyboard; depressing and holding an ALT key on the keyboard; depressing a PAGEDOWN key on the keyboard; and releasing the CTRL, ALT, and PAGEDOWN keys. Depressing the PAGEDOWN key on the keyboard may involve depressing and holding the PAGEDOWN key for at least 4 seconds to activate a forced power off event in the computer. These multiple key depressions assist in the avoidance of inadvertent keyboard activity that may cause undesirable changes in the computer's power state.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a block diagram of a basic computer interface extension solution according to principles of the present invention.

FIG. 2 is a block diagram of another basic computer interface extension solution wherein a manageability switch is introduced into the solution.

FIG. 3 is a block diagram of a computer interface extension solution wherein a manageability switch and multi-system switches are introduced into the solution.

FIG. 4 is a simplified diagram of a motherboard having an add-in card that allows communications with the motherboard according to principles of the present invention.

FIG. 5 is a block diagram of one configuration for the add-in card of FIG. 4.

FIG. 6 is a block diagram of a second configuration for the add-in card of FIG. 4.

FIG. 7 is a block diagram of a third configuration for the add-in card of FIG. 4.

FIG. 8 is a block diagram of a host computer system motherboard configuration according to principles of the present invention.

FIGS. 9A and 9B are flow diagrams that reflect one potential keystroke combination that is used to power on a host computer system such as the host computer system of FIG. 1.

FIGS. 10A and 10B are flow diagrams that reflect one potential keystroke combination that is used to power off a host computer system such as the host computer system of FIG. 1.

### DETAILED DESCRIPTION OF THE INVENTION

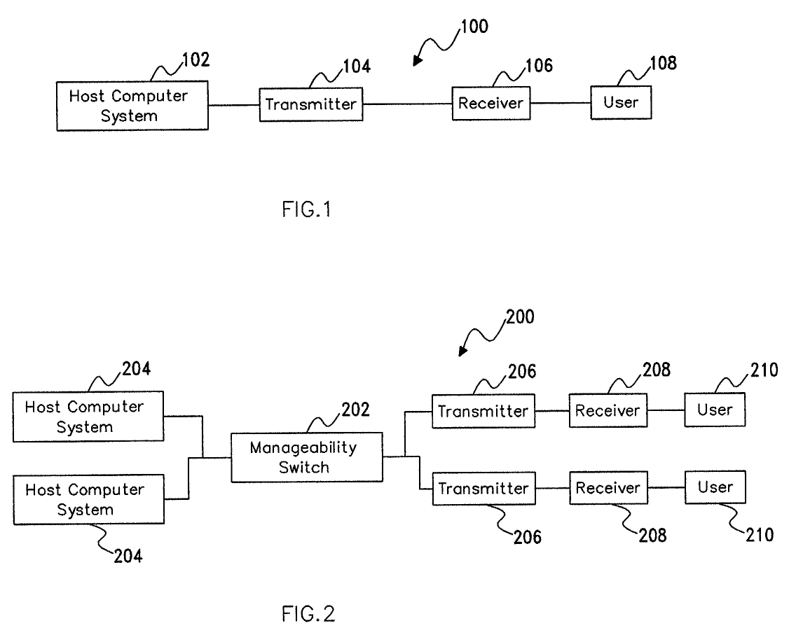

FIG. 1 is a block diagram of a basic computer interface extension solution 100 according to principles of the present invention. The extension solution 100 is illustrated as having a host computer system 102 with an extension transmitter 104 (herein referred to as “transmitter”). The transmitter 104 is connected to the extension receiver 106 (herein referred to as “receiver”) which is connected to a user 108. The user 108 is representative of standard user interface products such as a keyboard, mouse, monitor, serial port, audio devices, USB ports, etc. The keyboard operates with a PS/2, USB, or other type of implementation which is familiar to those of ordinary skill in the art. The extension solution 100 is commonly implemented as a KVM extension, however, as will be understood when viewing the description of the invention, the extension solution 100 may include more than KVM extension capabilities. Further, although data travels bi-directionally between the host computer system 102 and the user 108, to delineate the separation, the transmitter 104 and the receiver 106 are labeled as though data transfer occurs only in one direction, i.e., from the host computer system 102 to the user 108.

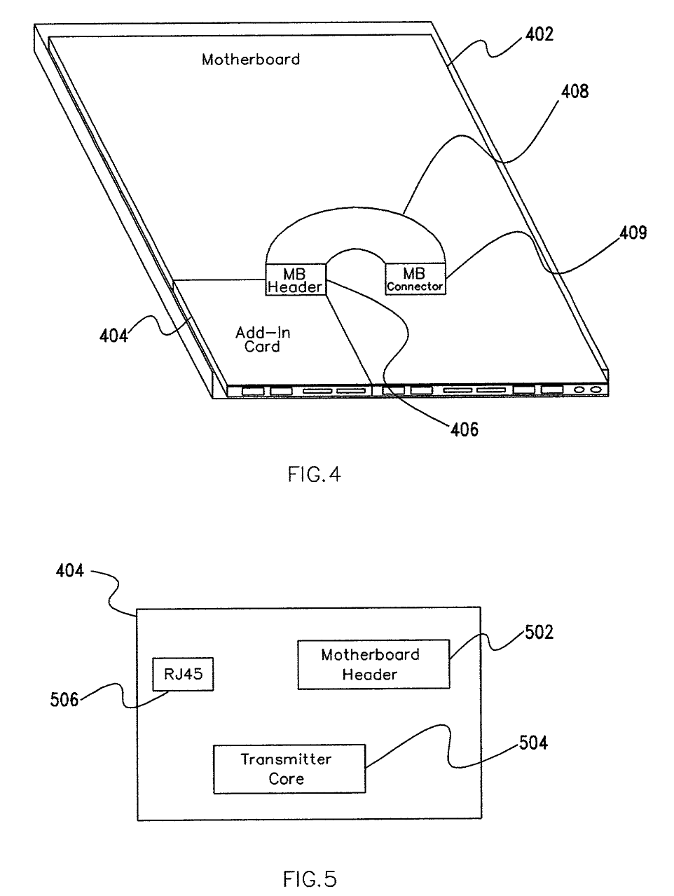

The transmitter 104 and receiver 106 are connected with a single cable such as a cable compatible with all versions of category 5, 6, 7, or better cables. The connection could also be made with fiber optic or other type of high speed data transmission cabling. The distance between the transmitter 104 and receiver 106 ranges approximately 300 meters. In this manner are the user interface devices of the user 108 allowed to communicate effectively with the host computer system 102 across long distances, “long” as compared to user/host communication distances in a system without the transmitter 104/receiver 106 pair. Although illustrated external to the host 102, the transmitter 104 may be positioned internal to the host computer system 102 and use an internal connector with the motherboard of the system 102 (see FIG. 4).

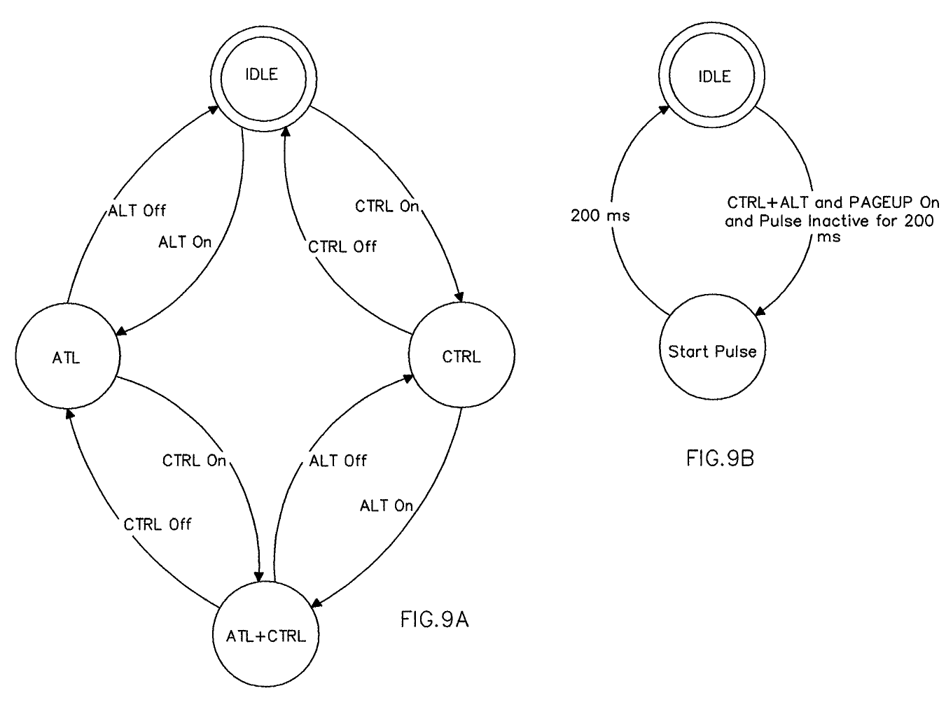

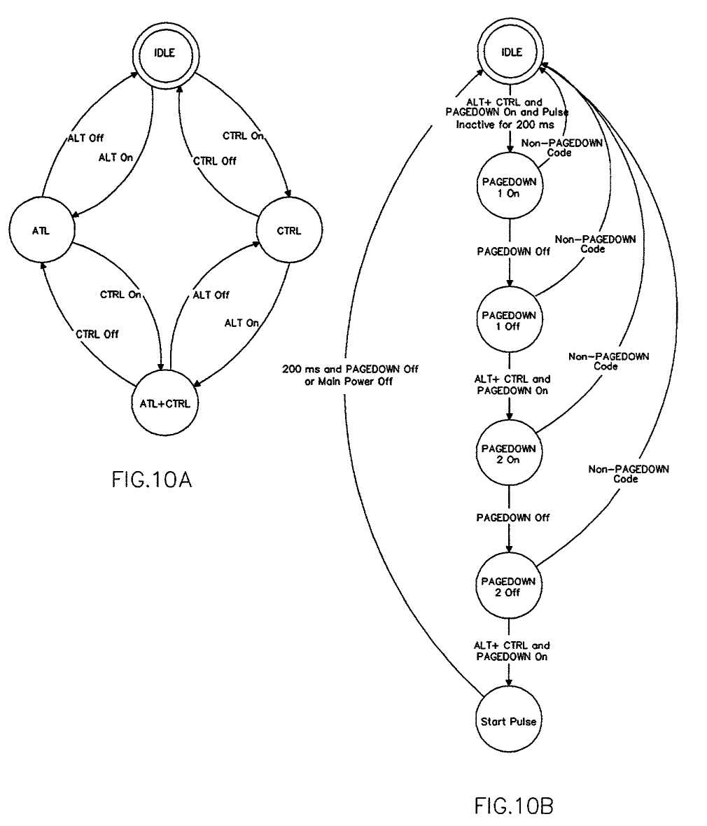

As understood from the above description, the user 108 may include a person entering keystrokes on a keyboard with such keystrokes producing signals that are transmitted to the host computer system 102. Certain keystroke combinations produce key codes that are transparent to the software layer of the computer system 102 and are recognized only by hardware such that the keystroke combination may be used to power on or off the host computer system 102. These keystroke combinations are programmable by the user as discussed in detail in regard to FIGS. 9 and 10. Of particular note, the power control keystrokes may be changed on the fly by a user. The currently programmed keystroke combination gives the user direct hardware control of the power button from the keyboard.

FIG. 2 is a block diagram of another basic computer interface extension solution 200 wherein a manageability switch 202 is introduced into the solution. The solution 200 includes multiple host computer systems 204, multiple transmitters 206, and multiple receivers 208 that support the communication extension for multiple users 210. The manageability switch 202 encompasses technology used to map a specific user to a specific system, to converge a large number of systems to a small number of users for system administration or head trader access, and to share a single system between two or more users.

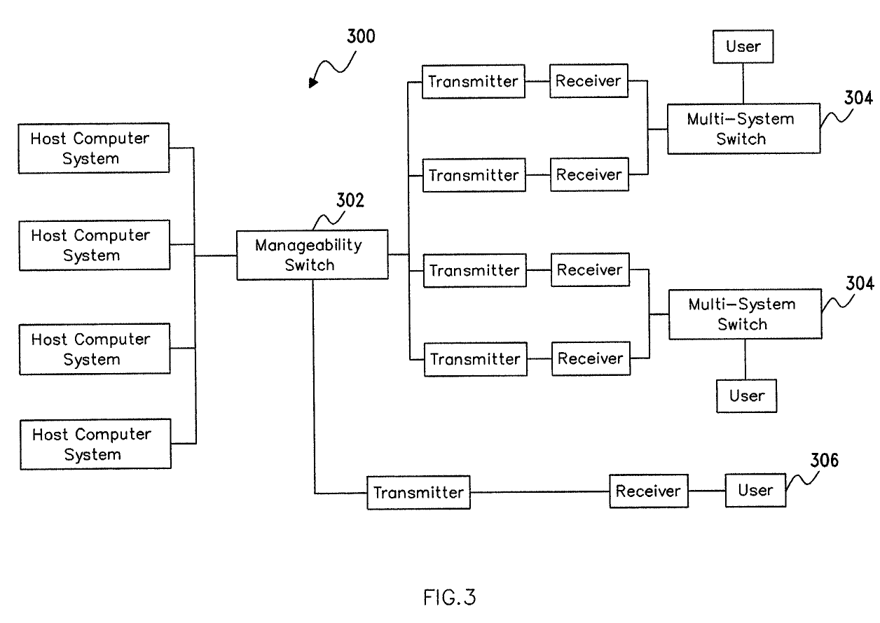

FIG. 3 is a block diagram of a computer interface extension solution 300 wherein a manageability switch 302 and multi-system switches 304 are introduced into the solution 300. An administrative user 306 is also illustrated that provides the capability to monitor the users 304 and make adjustments to the solution 300 configuration if necessary.

FIG. 4 is a simplified diagram of a motherboard 402 having an add-in card 404 that allows communications with the motherboard 402 according to principles of the present invention. The add-in card 404 is configured to operate as a transmitter in an extension solution such as a KVM extension solution. However, the add-in card 404 is not limited to KVM connections, but allows for power button, USB, and other connection types. Motherboard (MB) header 406, when connected by a cable 408 such as a ribbon cable to MB connector 409, allows the motherboard 402 to communicate directly with the add-in card 404 rather than only through an external connection between the motherboard 402 and the add-in card 404. This configuration eliminates the need for additional cables to be added externally to the host to communicate between the motherboard 402 and the add-in card 404, which is particularly desirable when the motherboard 402 is one of many motherboards in a rack mounted computer system.

As illustrated in the following figures, the add-in card 404 has various configurations for operation as a transmitter card.

FIG. 5 is a block diagram of one configuration for the add-in card 404. The add-in card 404 is configured with minimal circuitry components such that the motherboard performs most functions of the computer system. A motherboard header 502 acts as the primary interface with the motherboard and the functionality data of the motherboard is passed to a transmitter core 504 via the motherboard header 502 where the data is configured to be transmitted at a connector such as RJ-45 connector 506. Motherboard functionality data that is passed directly to the add-in card 404 commonly includes functions such as PS/2 mouse, PS/2 keyboard, USB 1.1 or 2.0, power button, card power, cable detect, analog video, digital video, analog audio, and RS-232 serial.

All functions can be included or excluded in the cable 408 definition as needed. For example, when RS-232 serial, digital and analog video, and audio functions are included in the functions, switching should occur on the motherboard to avoid conflicts and select between functional connectors on the motherboard and the add-in card 404. The add-in card 404 of FIG. 5 is considered to be a “dumb” card because the functionality is realized on the motherboard and passed to the add-in card 404 across the cable 408.

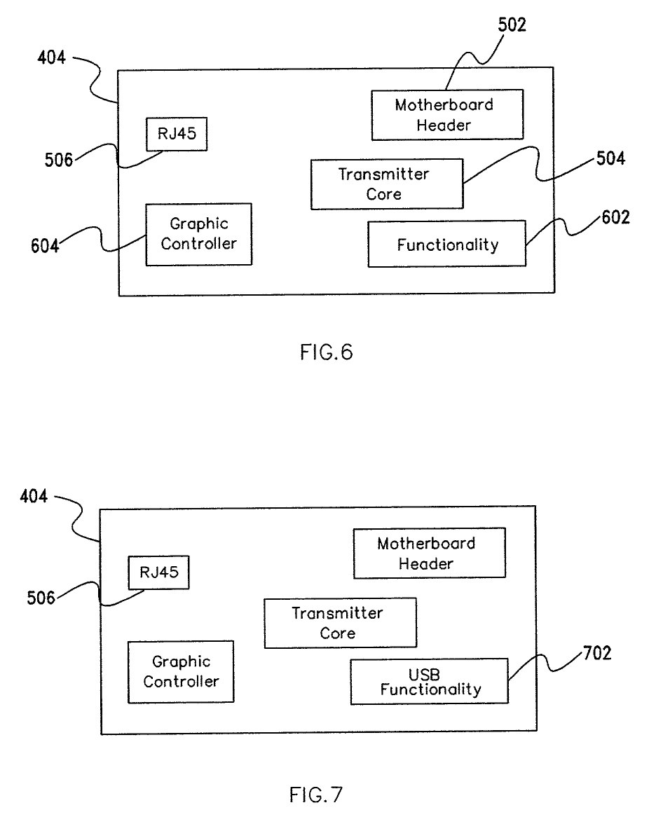

FIG. 6 is a block diagram of a second configuration for the add-in card 404. This configuration introduces functionality from the motherboard represented by functionality 602. The functionality 602 is flexible in that various degrees of motherboard functionality may be realized on the add-in card 404 itself, rather than on the motherboard and then transferred to the add-in card 404. In addition, a graphic controller 604 is included on the add-in card 404 for at least the reason that a slot may be opened on the motherboard. The graphic controller 604 may be compatible with PCI, AGP, or other protocol. For example, if the graphic controller 604 is PCI compatible, the add-in card 404 would be considered a PCI card and would plug into an available PCI slot while using the motherboard header 504 to communicate with other motherboard functionality that is not included in the functionality 602. Thus, an internal transmitter can be incorporated onto the motherboard without giving up an additional PCI slot on the motherboard. One type of functionality is supported when USB communications are converted to a PS/2-legacy type of protocol that is recognized by the extension receiver as the data is passed from the RJ-45 connector 506 of the transmitter add-in card 404.

FIG. 7 is a block diagram of a third configuration for the add-in card 404. A USB functionality component 702 is introduced such that the add-in card 404 operates using a USB protocol and transmits data from the RJ-45 connector 506 in a USB format. In one embodiment, the USB communications are extended by adding a USB hub that receives pure USB data and transmits raw data onto the extension where the receiver converts the signals back into USB format.

Of course, the USB functionality component 702 is exemplary of the different types of functions that may be implemented on the add-in card 404 rather than on the motherboard. For example, the functionality could include audio in/out signals and serial RS-232 protocols. One additional possibility is that the functionality 702 could include the capability to allow the computer system to recognize that the add-in card 404 is present in a computer thereby enabling enumeration of such add-in card 404.

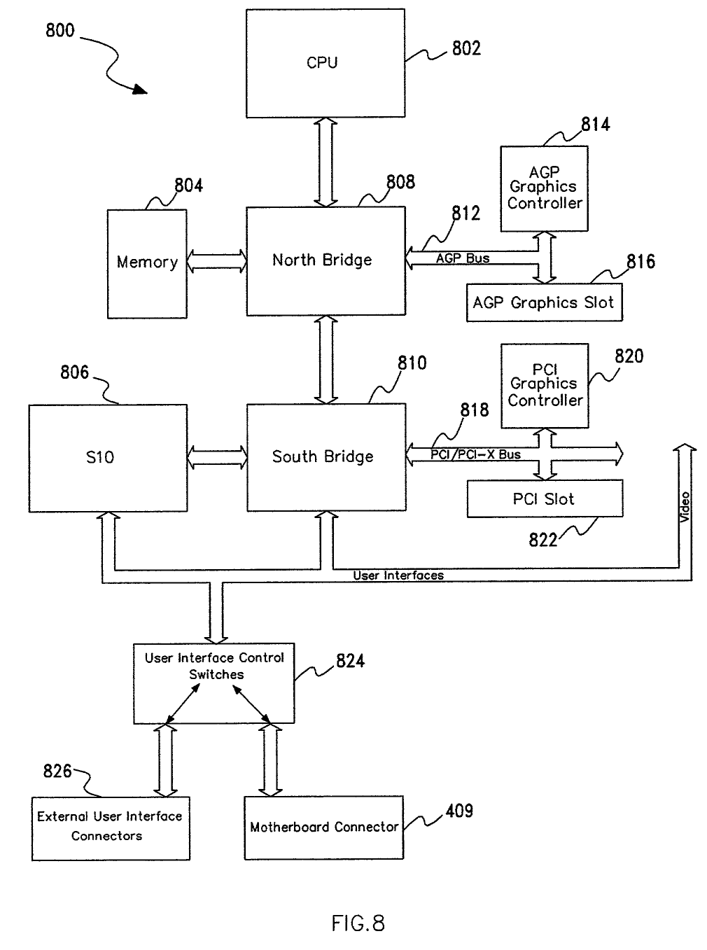

The functionality on the add-in card 404 is detected by the motherboard 402 and the functionality is also identified by the motherboard 402 to assist in driver selection for software programs that use the particular functionality while operating. USB functionality is supported through endpoint configuration. For example, a certain collection of endpoints may indicate that a USB audio device is present on the add-in card 404. Other collections of endpoints could indicate KVM devices. On the other hand, if the functionality is PCI compatible, the audio device is represented as a function in PCI configuration register space. Other interfaces are contemplated such as an AC '97 interface that is an interface defined to exist between an audio codec and the south bridge (see FIG. 8) of the motherboard. As understood by those of ordinary skill in the art, USB communications are initiated from a host by a USB host controller, independent of PCI enumeration type functions.

FIG. 8 is a block diagram of a host computer system motherboard configuration 800 according to principles of the present invention. A processor (CPU) 802, memory 804, and super I/O (SIO) 806 are illustrated to show motherboard communications across a north bridge 808 and a south bridge 810. The north bridge 808 provides an AGP bus 812 for AGP communications with either an AGP graphics controller 814 on the motherboard 800 or an AGP graphics slot 816 with an AGP graphics card (not shown) inserted. The AGP graphics card is a card such as the add-in card 404 with a graphic controller (e.g., graphic controller 604) compatible with AGP graphics communications.

The south bridge 810 provides a PCI/PCI-X bus 818 for PCI/PCI-X communications with either a PCI graphics controller 820 on the motherboard 800 or a PCI slot 822 with a PCI graphics card (not shown) inserted. The PCI graphics card is a card such as the add-in card 404 with a graphic controller (e.g. graphic controller 604) configured for PCI graphics communications.

The north bridge 808/south bridge 810 configuration allows one graphic controller to be enabled at a time. For example, if the north bridge 808 supports the AGP graphics controller 814, then there will be no other graphic controller. Alternatively, if the south bridge 810 supports the PCI graphics controller 820, then no other graphic controller is operational on the motherboard 800. Of note, the PCI slot 822 is representative of many slots that support PCI cards in general, not just a PCI graphics controller card. In other words, the add-in card 404 could have a PCI graphics controller and be inserted into the PCI slot 822 while other PCI cards are inserted into other PCI slots to communicate with the south bridge 810. Alternatively, the north bridge 808 may have an AGP graphics controller installed (either directly on the motherboard 800 or inserted in the AGP graphics slot 816) and non-graphic PCI communications may occur on the south bridge 810.

Significantly, as discussed above, the add-in card 404 has a motherboard header 406 for connecting directly to the motherboard connector 409. A user interface control 824 manages communications among the motherboard 800, the motherboard connector 409, and external user interface connections 826.

FIGS. 9A and 9B are flow diagrams that reflect one possible programmable keystroke combination that is used to power on the host computer system 102, i.e., CTRL, ALT, and PAGEUP are exemplary keystrokes because the user may program almost any combination of keystrokes to perform the power on function in hardware. It should be noted that the power on keystroke combination is applicable to computer systems with or without KVM extension hardware, but, for ease of understanding principles of the present invention, is described in relation to the KVM extension hardware. Also, the keystroke combination could be realized with PS/2, USB, or other implementation type keyboard.

FIG. 9A illustrates different states that exist depending on the order that a user follows when depressing a CTRL+ALT key combination. The CTRL+ALT keys are ‘modifier’ keys that are designed to change the interpretation of the function keys, but, as stated, are user programmable and are not required in every embodiment of the present invention. When the CTRL+ALT combination is depressed and held, then the PAGEUP key, i.e., any functional key or even combination of functional keys, may also be pressed to send a start pulse to the host computer system 102 as illustrated by the flow diagram of FIG. 9B. Of course, other keystroke combinations are possible as any key code may be configured/programmed for the power on event. Multiple keys are commonly used to aid in the reduction of inadvertent power on events by making use of modifier keys. The resulting key codes of the combination are “intercepted” by the computer hardware such that the software layer of the computer system 102 is bypassed. The power feature allows the user to turn on system power from the keyboard just like pressing the power button when the external power supply is connected and the internal power supply is off. In other words, a power button access point is created from the keyboard. The internal power supply provides minimal auxiliary power for miscellaneous operations, such as the power on feature, to avoid undesirable power button sequences.

FIGS. 10A and 10B are flow diagrams that reflect one potential keystroke combination that is used to power off the host computer system 102. This feature is available only when main power is on. Like the power on keystroke sequence of FIGS. 9A and 9B, although any keys may be configured to power the system off, the power off sequence of FIGS. 10A and 10B makes use of familiar modifier keys by depressing the CTRL+ALT keys combined with multiple pressing of the PAGEDOWN key. Of course, any functional key, or combination of functional keys, that has been programmed for the power off function could be used. A 4-second override feature that allows the power to be turned off regardless of whether the host computer system 102 is locked-up or frozen is included as an option in the key sequence. This feature demonstrates the importance of providing the hardware “interception” of particular key code combinations when the software layer is inoperable.

Like the power on sequence, the power off feature of FIGS. 10A and 10B requires multiple key presses in sequence. These sequences include the detection of key release codes. The event sequence of FIGS. 10A and 10B is defined as approximately 4 consecutive key presses. Multiple keys are depressed simultaneously and multiple times. Care must be taken to avoid defining a key sequence that has a chance of being used by an application. This avoids power off sequences from being used by applications and standard application use from triggering a power off event. The power button pulse to the host is initiated as the last keystroke in the sequence. The power button pulse is deactivated when the last keystroke is released.

The 4-second override function is activated when the last keystroke in the power off sequence is held active for four seconds. This is just like holding down the power button on the host computer.

It should be noted that the above keystroke combinations, or other keystroke event configurations, comply with industry standard power button specifications such as the ACPI (Advanced Configuration and Power Interface) standard and are programmed by the host through PCI, USB, SMBus, or other device configuration and operation.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1. A power control feature in a computer system comprising:
a host having a motherboard with a first connector that allows motherboard signals to be shared internal to the host, the motherboard also having at least a second connector separate from the first connector that supports communications with the host;
an extension transmitter card disposed within the host and being electrically coupled to the motherboard of the host via at least the first connector and the second connector, the extension transmitter card including an extension transmitter device having circuitry configured to recognize specific programmable key code combinations from a keyboard as indicating power control commands to the host; and
an extension receiver coupled to a plurality of user interface devices including the keyboard, the extension receiver being extensibly connected to the extension transmitter card.

2. The power control feature of claim 1 wherein the extension transmitter card comprises a peripheral connection interface graphics controller that communicates with the motherboard independent of communications on the first connector.

3. The power control feature of claim 1 wherein the extension transmitter card comprises an accelerated graphics port controller that communicates with the motherboard independent of communications on the first connector.

4. The power control feature of claim 1 wherein the plurality of user interface devices comprise the keyboard, a mouse, a video monitor, a speaker, a serial link, a USB link, and a microphone.

5. The power control feature of claim 1 wherein the extension receiver is extensibly connected to the extension transmitter via a fiber optic cable.

6. The power control feature of claim 1 wherein the extension receiver is extensibly connected to the extension transmitter via a cable compatible with any version of category five or above type cables.

7. The power control feature of claim 1 wherein the extension transmitter card disposed within the host is electrically coupled to the first connector of the motherboard of the host via a ribbon cable disposed between the motherboard and the extension transmitter card.

8. The power control feature of claim 1 wherein the extension transmitter card disposed within the host is electrically coupled to the second connector of the motherboard of the host via one of a PCI, PCI-X, or AGP interface with the extension transmitter card.

9. The power control feature of claim 1 wherein the specific programmable key code combination comprises a CTRL, ALT, and PAGEUP key combination that powers on the host when activated.

10. The power control feature of claim 1 wherein the specific programmable key code combination comprises a CTRL, ALT, and PAGEDOWN key combination that powers off the host when activated.

11. The power control feature of claim 10 wherein activating the specific programmable key code combination comprises holding the key combination for at least 4 seconds.

12. A power control feature in a computer system comprising:
a host having a motherboard; and
a keyboard electrically coupled to the motherboard, the motherboard having circuitry that is configured to recognize programmable key code combinations from the keyboard such that powering of the host may be controlled by depressing a specifically programmed key combination at the keyboard.

13. The power control feature of claim 12 wherein the keyboard is located remotely from the host and motherboard.

14. The power control feature of claim 12 wherein the specifically programmed key combination comprises a CTRL, ALT, and PAGEUP key combination that powers on the host when activated.

15. The power control feature of claim 12 wherein the specifically programmed key combination comprises a CTRL, ALT, and PAGEDOWN key combination that powers off the host when activated.

16. The power control feature of claim 15 wherein pressing the specifically programmed key combination activates a specific key code after holding the key combination for at least 4 seconds.

17. A method for power control in a computer using a standard keyboard comprising:
electrically connecting the keyboard to the computer;
depressing a specifically programmed key combination on the keyboard such that a unique key code sequence is transmitted to the computer;
the computer identifying the unique key code as a power control sequence; and
the computer bypassing software layer operations to enable internal power to be controlled by the power control sequence upon its receipt from the keyboard.

18. The method of claim 17 wherein said standard keyboard is positioned remotely from the computer.

19. The method of claim 17 wherein said depressing the specifically programmed key combination on the keyboard powers on the computer and comprises:
depressing and holding a CTRL key on the keyboard;
depressing and holding an ALT key on the keyboard;
depressing a PAGEUP key on the keyboard; and
releasing the CTRL, ALT, and PAGEUP keys.

20. The method of claim 17 wherein said depressing the specifically programmed key combination on the keyboard powers off the computer and comprises:
depressing and holding a CTRL key on the keyboard;
depressing and holding an ALT key on the keyboard;
depressing a PAGEDOWN key on the keyboard; and
releasing the CTRL, ALT, and PAGEDOWN keys.

21. The method of claim 20 wherein said depressing the PAGEDOWN key on the keyboard comprises depressing and holding the PAGEDOWN key for at least 4 seconds.
